(19) United States
(12) Patent Application Publication
(10) Pub. No.: US 2024/0101276 A1
(43) Pub. Date: Mar. 28, 2024

(54) Landing System for UAV with Rotatable Ring

(71) Applicant: STRIX DRONES LTD, Neve Yarak (IL)

(72) Inventors: Niv Aharoni, Neve Yarak (IL); Maoz Klein, Tel Aviv (IL)

(73) Assignee: STRIX DRONES LTD, Neve Yarak (IL)

(21) Appl. No.: 17/950,117

(22) Filed: Sep. 22, 2022

(51) Int. Cl. B64F 1/32; B64C 39/02

(52) U.S. Cl. CPC B64F 1/32; B64C 39/024; B64C 2201/128

(57) ABSTRACT

A landing system for an unmanned aerial vehicle that includes a flat platform having a central hole that serves as a landing board, a lifting board on which a package can be placed that is positioned horizontally in the central hole, a lifting mechanism for lifting up and lower down the lifting board, a rotatable ring that surrounds the enteral hole and embedded in the flat platform in such a way that it can be leveled with the flat platform, and a motor for rotating the rotatable ring. The unmanned aerial vehicle can be positioned on the rotatable ring in such a way that the it can be horizontally rotated by the rotatable ring.

### TECHNICAL FIELD

The present invention relates to a landing system for unmanned aerial vehicle.

### PRIOR ART

The use of unmanned aerial vehicles is increasing and requires innovations and solutions for pointing the unmanned aerial vehicle to a desirable direction. The present invention discloses a good and efficient solution for these needs.

### BRIEF DESCRIPTION OF THE FIGURES

FIG. 1 depicts schematically the landing system (1).

FIG. 2 depicts the flat platforn (21).

FIG. 3 depicts the flat platform (21) with the unmanned aerial vehicle.

FIG. 4 is a cross-sectional depiction of the landing system (1).

### THE INVENTION

The main objective of the present invention is to provide a landing system (1) for an unmanned aerial vehicle (200). The landing system (1) includes:

A flat platform (21) with a central hole (22). The flat platform is designed to serve as a landing board for the unmanned aerial vehicle.

A lifting board (31) on which a package (100) received from the unmanned aerial vehicle can be placed or loaded to the unmanned aerial vehicle. The lifting board is positioned horizontally in the central hole in such a way that the lifting board can be leveled with the flat platform.

A lifting mechanism (32) that is designed to lift up and lower down the lifting board.

A rotatable ring (6) that surrounds the central hole and is embedded in the flat platform in such a way that the rotatable ring can be leveled with the flat platform. However, it is possible that the landing system will have the option to lift up the rotating ring to be higher that the level of the flat platform.

A motor (61) that is designed to rotate the rotatable ring according to commands that can received from a controller (62) that is designed to operate the rotatable ring.

The unmanned aerial vehicle can be positioned on the rotatable ring in such a way that the unmanned aerial vehicle can be horizontally rotated by the rotatable ring.

The landing system may also incudes one or more conductive contact surfaces (64) that are attached to the flat platform, so that the controller can rotates the rotatable ring for directing one or more conductive pins (63) that are attached to the unmanned aerial vehicle to the one or more conductive contact surfaces for creating a communication connection between them.

The landing system may serve also for a landing of unmanned aerial vehicles that include one or more wings (64). In such cases, the controller is designed to receive information regarding a direction of a wind that flow over the landing system and designed to rotate the rotatable ring automatically for directing the wings against the wind flow before taking off. The controller can receive this information from wind sensors (66) or from a meteorological station (67) that may be an integral part of the landing system. The controller can be also designed to receive information regarding a direction in which the unmanned aerial vehicle should be pointed for enabling to place the package on the lifting board.

The rotatable ring is designed to rotate clockwise or counterclockwise, while the flat platform and the lifting board do not rotate but are in a fixed position. In essence, the main purpose of the rotating ring is to rotate the unmanned aerial vehicles in the direction of the wind when it has a fixed wing when it takes off, to rotate the unmanned aerial vehicles for causing the electrical connection between the conductive contact surfaces and the conductive pins for electrical communication of the landing system with the unmanned aerial vehicle, and also to enable the package to be placed properly on the lifting boards. It is possible to assemble four (or more or less) small feet (68) at the bottom of the landing gear of the unmanned aerial vehicle in order to enable the unmanned aerial vehicle to be placed firmly and stably on the rotatable ring. In general, the unmanned aerial vehicle lands on the flat platform. After that, the centering rods center it on the flat platform in such a way that it stands on the rotatable ring (with or without the small feet), and then (after the centering rods will return to their place) the rotatable ring rotates and directs the unmanned aerial vehicle according to the need, such as for facing the wind for taking off, for creating the electrical connection or for placing the package properly in place, as explained above.

In more other details, the landing system may include:

A landing pad (2) that comprise a flat platform (21) with or without a central hole (22) at the center (23), or about the center, of the flat platform. It is preferably that the flat platform will be made of materials and size as it is customary to design landing platforms for unmanned aerial vehicles. The purpose is to enable the unmanned aerial vehicle to land on the flat platform and take off from it safely and effectively.

An elevating subsystem (3) comprises a lifting board (31) and a lifting mechanism (32). The lifting mechanism (32) can be of any known type that can be used for lifting and lowering an elevator, and in this case, lifting and lowering the lifting board (31) that serves as an elevator. It is preferably that the lifting mechanism (32) will includes a guide rail (321), a guiding pulley (322) that fits the guide rail, a lifting cable (323) and a motor (324) for pulling up and loosing down the lifting cable on which the lifting board is hanged. The guide rail is fixed to the compartment subsystem (4), the guiding pulley is fixed to the lifting floor, and when they are assembled they define the track of the lifting board and also may control its speed and stopping pints.

A compartments subsystem (4) comprises plurality of compartments (41), one above the other, each of which has a pushing rod (42) that is equipped with an actuator (43). The compartments subsystem (4) includes plurality of compartments (41) into which the packages are transferred as needed. The lifting board can go down and stop in front of each compartment. The lifting board can stop in front of each compartment according to known mechanisms under which elevators stop at each floor of a building, for example, using sensors. The pushing rod may be a telescopic rod that is operated by the actuator and can move and push the package from the lifting board to the compartment.

The flat platform (21) of the landing pad (2) is designed to be suitable for the unmanned aerial vehicle (200) to land on it. The lifting board (31) is designed to be positioned horizontally in the central hole (22) of the flat platform, in such a way that it can be leveled with the flat platform (21) when the unmanned aerial vehicle (200) is landing on the landing pad (2). The lifting board (31) is suitable to receive the package (100) in a way that the unmanned aerial vehicle (200) can place the package on the lifting board.

After placing the package (100) on the lifting board (31), the lifting mechanism (32) goes into action and lowers the lifting board downwards and stops it in front of the compartment intended to receive the package. As explained before, the lifting mechanism (32) is designed to lift up and lower down the lifting board (31). It is possible that the unmanned aerial vehicle will place the package on the flat platform and the center rods will move it and place it on the lifting board.

The lifting board (31) is designed to stop in front of each compartment (41) according to need and the pushing rod (42) is designed to push the package from the lifting board to that compartment. The system may be designed for loading packages to the unmanned aerial vehicle or may be combined with the ability to load and receive packages. In these cases, the system may include a loading compartment (410), that can be one of the compartments (41) or a compartment specially designed for loading packages on the unmanned aerial vehicle. The loading compartment (410) includes a pushing loading rod (420) with a loading actuator (430) that pushes a package from the loading compartment to the lifting board so that the lifting board can lift the package up directly to the unmanned aerial vehicle for being loaded.

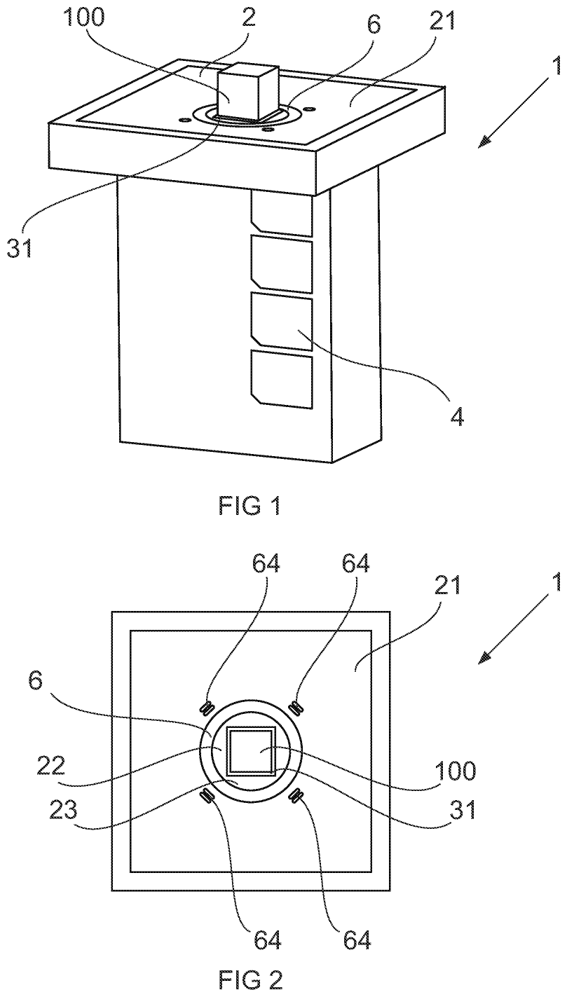

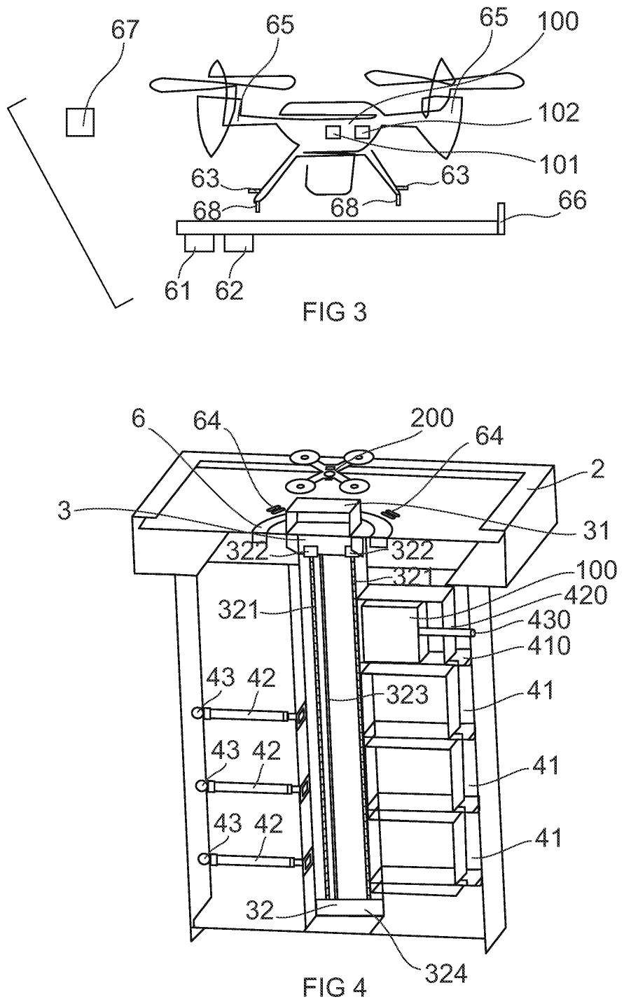

FIG. 1 depicts schematically the landing system (1), FIG. 2 depicts the flat platform (21), FIG. 3 depicts the flat platform (21) with the unmanned aerial vehicle, and FIG. 4 is a cross-sectional depiction of the landing system (1).

What is claimed is:

1. A landing system for an unmanned aerial vehicle, comprising:
a flat platform having a central hole, wherein said flat platform is designed to serve as a landing board for the unmanned aerial vehicle;
a lifting board on which a package received from the unmanned aerial vehicle can be placed; wherein the lifting board is positioned horizontally in the central hole in such a way that the lifting board can be leveled with the flat platform;
a lifting mechanism that is designed to lift up and lower down the lifting board;
a rotatable ring that surrounds the enteral hole and is embedded in the flat platform in such a way that the rotatable ring can be leveled with the flat platform;
a motor that is designed to rotate the rotatable ring according to commands that can received from a controller that is designed to operate the rotatable ring; and
wherein the unmanned aerial vehicle can be positioned on the rotatable ring in such a way that the unmanned aerial vehicle can be horizontally rotated by the rotatable ring.

2. The landing system of claim 1 that further incudes one or more conductive contact surfaces that are attached to said flat platform, and wherein said controller is designed to rotate said rotatable ring for directing one or more conductive pins that are attached to said unmanned aerial vehicle to the one or more conductive contact surfaces.

3. The landing system of claim 1, wherein said unmanned aerial vehicle includes one or more wings, and wherein said controller is designed to receive information regarding a direction of a wind that can flow over the landing system and further designed to rotate said rotatable ring for directing the one or more wings against the wind flow.

4. The landing system of claim 1, wherein said controller is designed to receive information regarding a direction in which the said unmanned aerial vehicle should be pointed for enabling to place said package on said lifting board.
